(19) United States
(12) Patent Application Publication
(10) Pub. No.: US 2008/0183874 A1
(43) Pub. Date: Jul. 31, 2008

(54) Method and Apparatus to Facilitate Secure Connection Provisioning

(75) Inventors: Devarajan Puthupparambil, Mt. Prospect, IL (US); J Schneider, Grayslake, IL (US)

Correspondence Address: UTSTARCOM, INC. / FETF, 120 S. LASALLE STREET, SUITE 1600, CHICAGO, IL, 60603-3406, US

(73) Assignee: UTSTARCOM, INC., Alameda, CA (US)

(21) Appl. No.: 11/668,778

(22) Filed: Jan. 30, 2007

(51) Int. Cl. G06F 15/16

(52) U.S. Cl. 709/227

(57) ABSTRACT

A transaction data processing node (200) can determine (101) that an opportunity to resume a secure connection with a remote-location Internet Protocol-based authorization terminal (204) is at least about to conclude and then automatically initiate (102) a new secure connection with the remote-location Internet Protocol-based authorization terminal notwithstanding that no current communication needs for such a connection exist. So configured, a new secure connection will more likely be available should the remote-location Internet Protocol-based authorization terminal have a corresponding need for such a secure connection.

### TECHNICAL FIELD

This invention relates generally to network-based secure communications with remote-location Internet Protocol-based authorization terminals.

### BACKGROUND

Network-based communications of various kinds are known in the art. This includes Internet Protocol-based communications between various devices and platforms. This includes, though is certainly not limited to, communications with remote-location Internet Protocol-based authorization terminals such as, but not limited to, so called point-of-sale (POS) terminals of various kinds, automatic teller machines (ATM's), and so forth. As used herein, “remote location” will be understood to typically refer to physical remoteness where the platform in question is separated by many miles (sometimes hundreds or even thousands of miles) from a corresponding authorization host. In an illustrative example, this might comprise the essentially ubiquitous point-of-sale credit card transaction authorization terminals as are employed by nearly all retail establishments in many countries.

Such remote-location Internet Protocol-based authorization terminals are typically configured to establish a connection to an authorization host on an as-needed basis. In a typical application scenario these connections comprise secure connections (such as a secure sockets layer (SSL)-based connection, a transport layer security (TLS)-based connection, or the like) that provides for conversion of at least some or all of the communication payload to be conveyed to an encrypted form to thereby discourage unauthorized monitoring and usage. The methodology and protocols to employ when establishing such a secure connection are known in the art.

In some cases, the time required to establish a secure connection can be relatively burdensome (particularly as compared to the overall time required to otherwise effect a given transaction authorization request). This time may or may not be particularly noticeable to a platform user but can, when viewed in the aggregate over many tens of thousands of such platforms, represent considerable network overhead. This, in turn, has led to efforts to mitigate such temporal requirements.

By at least one prior art approach a secure Internet Protocol-based context (such as a secure sockets layer context), once established for a given point-of-service terminal, persists in a resumable form notwithstanding the conclusion of the authorization session that prompted its establishment. If and when the corresponding point-of-service terminal initiates another such session within a given period of time that makes use of that secure context (in particular, the previously negotiated security parameters), that previously established secure sockets layer context is resumed.

While suitable to meet the needs of many application settings, there are situations that remain unmet by such a solution. As one illustration in this regard, such an approach typically remains insufficient to meet the requirements of clients that persist beyond the aforementioned given period of time beyond which such reuse cannot be extended. This particularly includes, for example, point-of-service terminals that make a significant number of transactions but with successive call intervals greater than this predetermined period of time.

### BRIEF DESCRIPTION OF THE DRAWINGS

The above needs are at least partially met through provision of the method and apparatus to facilitate secure connection provisioning described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a flow diagram as configured in accordance with various embodiments of the invention; and

FIG. 4 comprises a call flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a transaction data processing node can determine that an opportunity to resume a secure connection with a remote-location Internet Protocol-based authorization terminal is at least about to conclude and then automatically initiate a new secure connection with the remote-location Internet Protocol-based authorization terminal notwithstanding that no current communication needs for such a connection exist. So configured, a new secure connection will more likely be available should the remote-location Internet Protocol-based authorization terminal have a corresponding need for such a secure connection.

By one approach, such automatic initiation can comprise a background task and hence reduce corresponding computational overhead (as well as network overhead) requirements. If desired, this automatic initiation can itself comprise a determination regarding whether such initiation should, in fact, be undertaken for a given remote-location Internet Protocol-based authorization terminal. Such a determination can be based, for example, upon information that tends to suggest whether such a secure connection will in fact be utilized within some reasonable period of time.

So configured and arranged, these teachings permit speed of access to be well balanced with network resources and client needs. Those skilled in the art will understand and appreciate that these teachings can be readily implemented in a cost effective manner and permit great leveraging of existing platforms and approaches. It will also be appreciated that these teachings are readily scalable and can accommodate usage with a relatively large population of remote-location Internet Protocol-based authorization terminals.

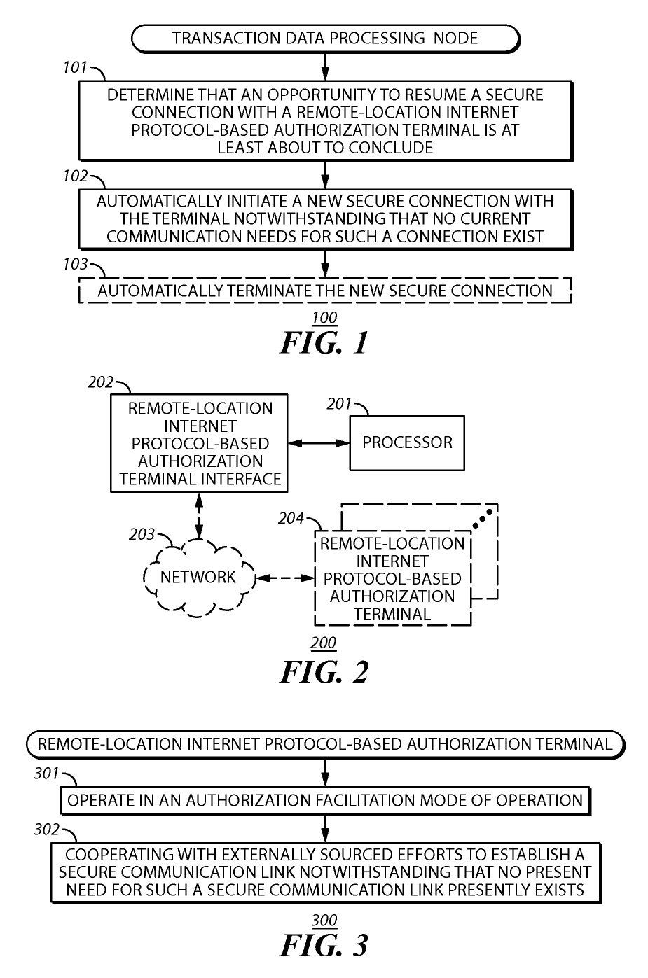

These and other benefits may become clearer upon making a thorough review and study of the following detailed description. Referring now to the drawings, and in particular to FIG. 1, an exemplary process 100 suitable for use by, for example, a transaction data processing node such as, but not limited to, a packet switching node will be described. This process 100 begins with determining 101 that an opportunity to resume a secure connection with a remote-location Internet Protocol-based authorization terminal is at least about to conclude. The secure connection itself can comprise, for example, a secure sockets layer (SSL) connection or a transport layer security (TLS) connection as are known in the art with other possibilities existing as well. The remote-location Internet Protocol-based authorization terminal can comprise any of a wide variety of authorization facilitation platforms. For the sake of simplicity and for the purposes of illustration but not limitation, the remainder of this description will presume that the remote-location Internet Protocol-based authorization terminal comprises a point-of-sale terminal that serves, for example, to authorize credit and/or debit transactions.

This process 100 is suitable for use with existing practices regarding the resumption of already-established secure communications session parameters and the like. In such a case, for example, this step of determining 101 that such an opportunity is at least about to conclude can comprise determining that the opportunity has concluded (as when a predetermined window of opportunity has expired). As another example, such a determination can be based upon determining that a resume-session timeout window (as is known in the art) is about to expire or has expired.

Upon making such a determination 101, this process 100 then provides for automatically initiating 102 a new secure connection with the remote-location Internet Protocol-based authorization terminal notwithstanding that no current communication needs for such a connection exist. So configured, for example, this step will provide for initiating a new secure connection even when the corresponding remote-location Internet Protocol-based authorization terminal is not engaged in a current communication session that is availing itself of a secure connection. By this approach, the new secure connection will more likely be available should the remote-location Internet Protocol-based authorization terminal have a corresponding future need for such a secure connection (to facilitate, for example, a future transaction authorization session).

When the expiring (or expired) secure connection comprises a secure sockets layer connection, this step can provide for automatically initiating a new secure sockets layer connection. In such a case, by one approach, it is the transaction data processing node itself that initiates the connection as versus the remote-location Internet Protocol-based authorization terminal. Though highly contrary to prior art practice in this regard, it will be seen that such an approach nevertheless offers certain advantages that are well leveraged by these teachings.

As noted above, establishing the basis for a secure connection (such as a secure sockets layer connection) can comprise a relatively computationally intensive and/or time consuming activity. Accordingly, if desired, these teachings will accommodate conducting this step as a background task to the other activities and functionality of the transaction data processing node. This will be understood by those skilled in the art to mean that the computational activities in support of establishing a new secure connection are conducted with a reduced priority in comparison to the real time needs and functionality of the transaction data processing node. To illustrate, effecting this step can be handled in a piecemeal fashion in between responding to current requests for transaction authorization connections from other remote-location Internet Protocol-based authorization terminals.

If desired, this step of automatically initiating 102 a new secure connection can itself comprise determining whether to initiating a new secure connection with a given remote-location Internet Protocol-based authorization terminal. Such a determination can be predicated upon such criteria as may be of interest and concern to a given administrator. By one approach, if desired, such a determination can be based, at least in part, upon a historical record of the remote-location Internet Protocol-based authorization terminal's usage of such a secure connection. This can comprise historical information regarding any or all of such examples as:

Short-term transaction history (such as, for example, a corresponding number of transactions as have been carried out by the remote-location Internet Protocol-based authorization terminal within some corresponding recent period of time such as the last ten minutes);

Long-term transaction history (such as, for example, a corresponding number of transactions as have been carried out by the remote-location Internet Protocol-based authorization terminal within some corresponding longer timer period of time such as the last hour, day, week, or the like);

A present time of day (at, for example, the geographic location of the remote-location Internet Protocol-based authorization terminal);

A present day of the week;

A present seasonal consideration (to account, for example, for the Friday following the United States Thanksgiving holiday when retail sales are traditionally high along with corresponding point-of-service transaction authorization requests);

and so forth, to note but a few examples in this regard. Those skilled in the art will recognize that the source of such information can vary with the application setting. By one approach, the transaction data processing node itself can track and accumulate such data. By another approach, alone or in combination with the foregoing, a remote data source may be accessible to the transaction data processing node to provide access to such information.

So configured, this step of determining to automatically initiate a new secure connection with a given remote-location Internet Protocol-based authorization terminal can, in turn, be based upon a determination regarding whether such a new secure connection should be established for such a user based, at least in part, upon information that tends to suggest or confirm how likely that platform is to need such a secure connection within some useful period of time.

As noted, this step of automatically initiating a new secure connection can occur as a background task. This, in turn, can potentially lengthen the period of time required to effect such a result. Also as noted above, it is the transaction data processing node that effects this step as versus the remote-location Internet Protocol-based authorization terminal itself. Accordingly, it is possible for the remote-location Internet Protocol-based authorization terminal to present its own request for a new secure connection prior to when the transaction data processing node completes the initiation of a new secure connection as per this step. In such a case, if desired, this process 100 will further accommodate automatically terminating initiation of the new secure connection when the remote-location Internet Protocol-based authorization terminal initiates establishment of another secure connection before initiation of the new secure connection is completed. In some application settings, it may also be possible to apply progress-to-date with respect to establishing a new secure connection for the benefit of the new request as proffered by the remote-location Internet Protocol-based authorization terminal.

Once newly established, this process 100 can accommodate using that secure connection for transaction authorization purposes using, for example, prior art practices in this regard. This process 100 will also optionally accommodate, if desired, automatically terminating 103 the new secure connection when appropriate. Such an action may be warranted, for example, upon determining that a secure connection is not likely to comprise a near term need of the remote-location Internet Protocol-based authorization terminal. By one approach, such a conclusion can be based, for example, upon noting that the remote-location Internet Protocol-based authorization terminal has not made use of the newly established secure connection within some predetermined period of time (such as a given number of seconds, minutes, hours, or the like).

This process 100 will also accommodate such termination 103 upon an expiration of some predetermined period of time (such as, for example, fifteen minutes, 60 minutes, and so forth) regardless of how often the corresponding remote-location Internet Protocol-based authorization terminal may have used this secure connection. Such an action may be appropriate, for example, to aid in preventing unauthorized parties from learning of the enabling secure connection parameters and exploiting them for some unauthorized purpose. In such a case, this process 100 can also then provide for repeating steps 101 and 102 to thereby provide again for re-establishment of a secure connection for a given busy remote-location Internet Protocol-based authorization terminal.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

In this illustrative example the switching packet node 200 comprises a processor 201 that operably couples to a remote-location Internet Protocol-based authorization terminal interface 202. The latter can comprise, for example, a hardware and/or software-based platform to facilitate compatible Internet Protocol-based interactions with a serviced population of remote-location Internet Protocol-based authorization terminals 204 via one or more intervening networks 203 (such as an extranet such as the Internet and so forth). The processor 201, in turn, can serve to effect some or all of the steps and functionality set forth above. This can be accomplished using, for example, programming or the like as will be well understood by those skilled in the art. By this approach, the processor 201 can specifically be configured and arranged to determine when an opportunity to resume a secure connection with a remote-location Internet Protocol-based authorization terminal is at least about to conclude and to then automatically initiate a new secure connection with the remote-location Internet Protocol-based authorization terminal notwithstanding that no current communication needs for such a connection exist.

Those skilled in the art will recognize and understand that such an apparatus 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

With reference to FIG. 3, a corresponding process 300 suitable for use by a given remote-location Internet Protocol-based authorization terminal will now be described. Pursuant to this process 300, the remote-location Internet Protocol-based authorization terminal can operate in an authorization facilitation mode of operation (which may comprise, for example, serving in accord with present prior art practice in this regard). This can comprise, for example, seeking to establish a new secure connection when no such connection exists pursuant to a resume-connection protocol and when a current need for such a connection exists in order to conduct an existing transaction authorization activity.

This process 300 can then provide for the remote-location Internet Protocol-based authorization terminal cooperating with externally sourced efforts (such as those described herein and as are sourced by a transaction data processing node through which the remote-location Internet Protocol-based authorization terminal ordinarily conducts authorization messages during the authorization facilitation mode of operation) to establish a secure communication link notwithstanding that no present need for such a secure communication link presently exits. This, of course, runs wholly contrary to present prior art practice in this regard. Accordingly to present practice, such a remote-location Internet Protocol-based authorization terminal will effectively ignore such efforts when operating in such a mode of operation. Configured as described, however, the remote-location Internet Protocol-based authorization terminal can aid in facilitating the establishment and availability of such a resource.

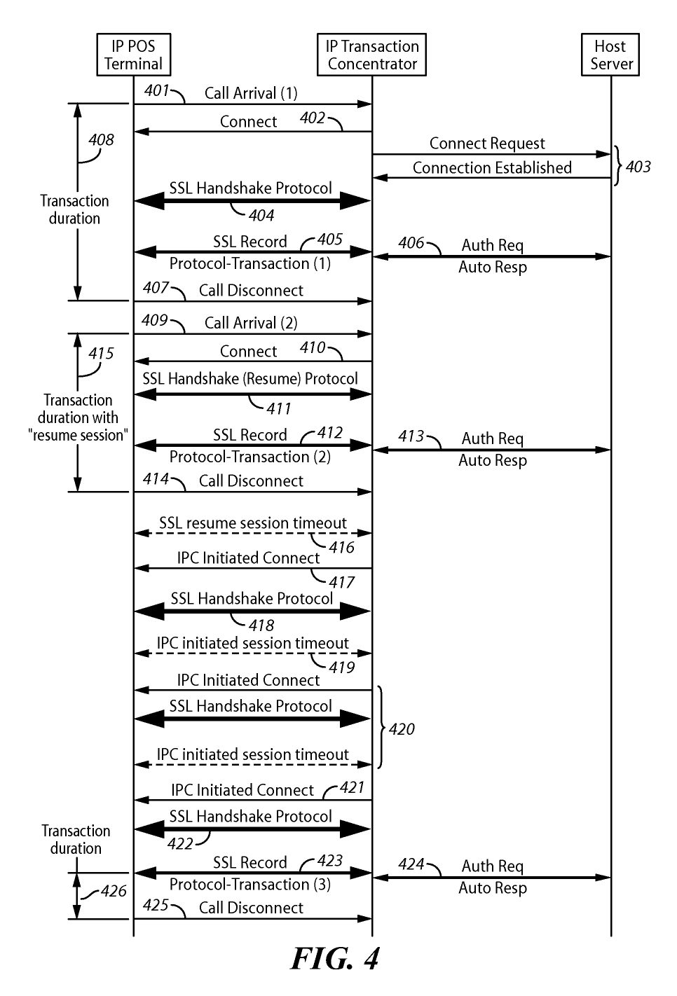

Some illustrative examples will now be provided with reference to FIG. 4. Those skilled in the art will recognize and understand again that the details of these examples are intended to serve only in an illustrative capacity and are not to be taken as an exhaustive presentation of all possibilities in this regard.

In a first example, an Internet Protocol point-of-service terminal (IP POS Terminal) exchanges call arrival 401 and connect 402 messages with a transaction data processing node that comprises, in this example, an Internet Protocol (IP) transaction concentrator. The latter then responds by submitting a connect request message to a corresponding host server and receiving a corresponding connection established message 403 therefrom. The IP transaction concentrator and the IP POS terminal then effect secure sockets layer handshake protocol activities 404 to establish the basis for a corresponding secure communications session that comprises a transaction message 405 session. The IP transaction concentrator and the host server exchange a corresponding authorization request and response 406 that leads, in this example, to providing the requested authorization to the IP POS terminal. This transaction completed, the IP POS terminal then transmits a corresponding call disconnect message 407.

The above example is consistent with prior art practice and essentially describes what happens when an IP POS terminal initiates a transaction authorization request in the absence of any already-established secure sockets layer parameters of record. In such a case, the total transaction duration 408 will typically represent a maximum amount of time as the secure session parameters must be developed during the course of the transaction session.

In the next example, it is presumed that the platforms involved employ a secure parameters reuse/resume scheme. Accordingly, in this example, following the above example and prior to the resume session timeout having been reached, the IP POS terminal again transmits a call arrival message 409 to the IP transaction concentrator which responds with a connect message 410 as before. In this case, however, the IP transaction concentrator and the IP POS terminal are able to effect the secure sockets layer handshake resume protocol 411 and are therefore able to resume use of the previously established secure sockets layer information and avoid re-establishing such information anew. A corresponding secure sockets layer record protocol-based transaction 412 and authorization request/response 413 then follow, following which the IP POS terminal again transmits a call disconnect message 414.

In the above example, where the platforms are able to make use of a resume session protocol provided in the prior art, the total transaction time 415 will typically be less than the transaction duration 408 for the preceding example. Proceeding further with these examples, however, the resume session window finally times out 416. Such expiration is a known prior art practice and serves to protect the overall integrity of the system's security by preventing a given set of secure session parameters from being used for an undue period of time.

When this occurs, as shown in the next example and as per the present teachings, the IP transaction concentrator itself initiates a connection 417 with the IP POS terminal following which a new secure sockets layer handshake protocol session 418 is observed. Those skilled in the art will note that no particular specific need for such a session exists at this time for this IP POS terminal. With this in mind, and again as per these present teachings, the IP transaction concentrator can attend to this particular session 418 as a background function.

As noted above, the persistence of a given set of secure communications parameters can present a risk to the integrity of a given system's security. With this in mind, a timeout of choice can be used to terminate an ability to use these newly-negotiated security parameters. In this example, such a time 419 occurs, and the IP transaction concentrator again repeats the just-described series of communications and activities 420 to again establish a new secure sockets layer session which, in this example, again expires 420 through a time out mechanism.

Following a new connection 421 and fresh observance of the secure sockets layer protocol 422 as per these teachings, however, in this example the IP POS terminal makes use of the pre-existing secure transaction setting to effect a corresponding secure sockets layer protocol-based transaction 423 (which in turn leads to the exchange of an authorization request and an authorization response 424 between the IP transaction concentrator and the host server as before). The transaction completed, the IP POS terminal again transmits a call disconnect message 425.

Those skilled in the art will recognize and understand that the total transaction duration 426 in this last example will typically be less than either of the previously described examples. These savings in time arise, at least in part, due to the pre-establishment of the secure connection details prior to the IP POS terminal actually needing such resources. It will also be understood that, in the examples provided above, the IP transaction concentrator can make one or more determinations regarding whether to re-initiate a secure session with any particular IP POS terminal. Such a determination can be based, as noted above, on some assessment regarding the likelihood that the IP POS terminal will need such a resource within some reasonable period of time.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a transaction data processing node:
determining that an opportunity to resume a secure connection with a remote-location Internet Protocol-based authorization terminal is at least about to conclude;
automatically initiating a new secure connection with the remote-location Internet Protocol-based authorization terminal notwithstanding that no current communication needs for such a connection exist, such that the new secure connection will more likely be available should the remote-location Internet Protocol-based authorization terminal have a corresponding need for such a secure connection.

2. The method of claim 1 wherein the secure connection comprises a secure sockets layer (SSL) connection.

3. The method of claim 1 wherein determining that an opportunity to resume a secure connection with a remote-location Internet Protocol-based authorization terminal is at least about to conclude comprises determining that the opportunity to resume the secure connection with the remote-location Internet Protocol-based authorization terminal has concluded.

4. The method of claim 1 wherein determining that an opportunity to resume a secure connection with a remote-location Internet Protocol-based authorization terminal is at least about to conclude comprises determining that a resume-session timeout window is at least about to expire.

5. The method of claim 1 wherein automatically initiating a new secure connection with the remote-location Internet Protocol-based authorization terminal comprises automatically initiating the new secure connection with the remote-location Internet Protocol-based authorization terminal as a background task.

6. The method of claim 1 wherein automatically initiating a new secure connection with the remote-location Internet Protocol-based authorization terminal comprises determining whether to initiate the new secure connection with the remote-location Internet Protocol-based authorization terminal.

7. The method of claim 6 wherein determining whether to initiate the new secure connection with the remote-location Internet Protocol-based authorization terminal comprises basing the determining, at least in part, upon a historical record of the remote-location Internet Protocol-based authorization terminal's usage of a secure connection.

8. The method of claim 1 wherein automatically initiating a new secure connection with the remote-location Internet Protocol-based authorization terminal comprises automatically terminating initiation of the new secure connection when the remote-location Internet Protocol-based authorization terminal initiates establishment of another secure connection before initiation of the new secure connection is completed.

9. The method of claim 1 further comprising:
automatically terminating the new secure connection.

10. The method of claim 9 wherein automatically terminating the new secure connection comprises determining that a secure connection is not likely to comprise a near term need of the remote location Internet Protocol-based authorization terminal.

11. A transaction data processing node comprising:
a remote-location Internet Protocol-based authorization terminal interface;
a processor operably coupled to the remote-location Internet Protocol-based authorization terminal interface and being configured and arranged to:
determine that an opportunity to resume a secure connection with a remote-location Internet Protocol-based authorization terminal is at least about to conclude;
automatically initiate a new secure connection with the remote-location Internet Protocol-based authorization terminal notwithstanding that no current communication needs for such a connection exist, such that the new secure connection will more likely be available should the remote-location Internet Protocol-based authorization terminal have a corresponding need for such a secure connection.

12. The transaction data processing node of claim 11 wherein the secure connection comprises a secure sockets layer (SSL) connection.

13. The transaction data processing node of claim 11 wherein the processor is further configured and arranged to determine that an opportunity to resume a secure connection with a remote-location Internet Protocol-based authorization terminal is at least about to conclude by determining that the opportunity to resume the secure connection with the remote-location Internet Protocol-based authorization terminal has concluded.

14. The transaction data processing node of claim 11 wherein the processor is further configured and arranged to determine that an opportunity to resume a secure connection with a remote-location Internet Protocol-based authorization terminal is at least about to conclude by determining that a resume-session timeout window is at least about to expire.

15. The transaction data processing node of claim 11 wherein the processor is further configured and arranged to automatically initiate a new secure connection with the remote-location Internet Protocol-based authorization terminal by automatically initiating the new secure connection with the remote-location Internet Protocol-based authorization terminal as a background task.

16. The transaction data processing node of claim 11 wherein the processor is further configured and arranged to automatically initiate a new secure connection with the remote-location Internet Protocol-based authorization terminal by determining whether to initiate the new secure connection with the remote-location Internet Protocol-based authorization terminal.

17. The transaction data processing node of claim 16 wherein the processor is further configured and arranged to determine whether to initiate the new secure connection with the remote-location Internet Protocol-based authorization terminal by basing the determining, at least in part, upon a historical record of the remote-location Internet Protocol-based authorization terminal's usage of a secure connection.

18. The transaction data processing node of claim 11 wherein the processor is further configured and arranged to automatically initiate a new secure connection with the remote-location Internet Protocol-based authorization terminal by automatically terminating initiation of the new secure connection when the remote-location Internet Protocol-based authorization terminal initiates establishment of another secure connection before initiation of the new secure connection is completed.

19. The transaction data processing node of claim 11 wherein the processor is further configured and arranged to automatically terminate the new secure connection.

20. The transaction data processing node of claim 19 wherein the processor is further configured and arranged to automatically terminate the new secure connection by determining that a secure connection is not likely to comprise a near term need of the remote location Internet Protocol-based authorization terminal.

21. The transaction data processing node of claim 11 wherein the processor comprises:
means for determining that an opportunity to resume a secure connection with a remote-location Internet Protocol-based authorization terminal is at least about to conclude; and
means for automatically initiating a new secure connection with the remote-location Internet Protocol-based authorization terminal notwithstanding that no current communication needs for such a connection exist, such that the new secure connection will more likely be available should the remote-location Internet Protocol-based authorization terminal have a corresponding need for such a secure connection.

22. A method comprising:
at a remote-location Internet Protocol-based authorization terminal:
operating in an authorization facilitation mode of operation;
while operating in the authorization facilitation mode of operation, cooperating with externally sourced efforts to establish a secure communication link notwithstanding that no present need for such a secure communication link presently exits.

23. The method of claim 22 wherein cooperating with externally sourced efforts to establish a secure communication link comprises cooperating with externally sourced efforts from a transaction data processing node through which the remote-location Internet Protocol-based authorization terminal conducts authorization messages during the authorization facilitation mode of operation.
